(19) United States
(12) Patent Application Publication
(10) Pub. No.: US 2022/0281643 A1
(43) Pub. Date: Sep. 8, 2022

(54) RETRACTABLE CARRYING CONTAINER

(71) Applicant: Shih-Yao CHEN, Taipei City (TW)

(72) Inventor: Shih-Yao CHEN, Taipei City (TW)

(21) Appl. No.: 17/195,524

(22) Filed: Mar. 8, 2021

(51) Int. Cl. B65D 25/34; A45D 34/02

(52) U.S. Cl. CPC B65D 25/34; A45D 34/02; A45D 2200/057

(57) ABSTRACT

A retractable carrying container is provided, comprising an outer shell, an inner shell, and corresponding first and second threads. The outer shell is a hollow cylinder, and the inner shell is arranged inside the outer shell. An application head is installed on the inner shell. The outer surface of the inner shell has an upper stopper and a lower stopper, the upper stopper is arranged on the upper edge of the second thread, the lower stopper is arranged at the lower edge of the second thread, and the outer shell and the inner shell move with respect to each other by the interaction of the first thread and the second thread.

### BACKGROUND OF THE INVENTION

### 1. Field of the Invention

The present invention relates generally to a retractable carrying container, and more particularly, to a carrying container having an outer shell, an inner shell, a first thread and a second thread, with the outer shell and the inner shell moving with respect to each other through the mutual action of the first thread and the second thread.

### 2. The Prior Arts

To highlight personal style, many people, in addition to choosing the style of clothing, often wear different accessories to more clearly highlight their personal style, thereby distinguishing themselves from other people's fashion styles.

However, with various decorative accessories, such as necklaces, bracelets, hanging decorations and pendants, and so on, the traditional accessories often only designed for a single function, i.e., decorative purpose, and no additional functions.

As the key ring is handy to keep the different keys together, such as house, office, and car, almost everyone has a key ring, and the key ring is also often dangled with decorations, such as, plush toys, puppets, pens, tools or some handicrafts, and so on.

In combination with the above, most of the existing key rings and accessories have no additional functions except for the decorative purpose. Moreover storing or carrying the key rings in a pocket often takes up considerable space and inevitably cumbersome.

As such, a retractable carrying container is desired to be provided for providing a solution in accordance with the foregoing disadvantages of the conventional products.

### SUMMARY OF THE INVENTION

The present invention provides a retractable carrying container, comprising: an outer shell, an inner shell, a first thread, and a second thread corresponding to the first thread.

Wherein, the first thread is located on an inner surface of the outer shell, the second thread is located on an outer surface of the inner shell, and the first thread and the second thread are in contact with each other and tightly fit.

Preferably, an application head is further included, and the application head is disposed on the inner shell.

Preferably, the outer shell is a hollow cylinder, and the inner shell is arranged in the space of the hollow cylinder of the outer shell.

Preferably, the outer shell and the inner shell move with respect to each other by the mutual action of the first thread and the second thread.

Preferably, the outer surface of the inner shell further comprises an upper stopper and a lower stopper, the upper stopper is arranged on upper edge of the second thread, and the lower stopper is arranged on lower edge of the second thread.

Preferably, the inner shell further comprises a carrying space with an opening, that is, an unsealed carrying space.

Preferably, the total stroke length of the second thread is greater than the total stroke length of the first thread, and the inner shell moves between the upper stopper and the lower stopper.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a schematic view showing of the retractable carrying container of the present invention;

FIG. 2 is a partial enlarged view showing of the retractable carrying container of the present invention;

FIG. 3 is another schematic view showing of the retractable carrying container of the present invention;

FIG. 4 is another partial enlarged view showing of the retractable carrying container of the present invention; and

FIG. 5 is a schematic view showing of the retractable carrying container of the present invention in actual application.

### DETAILED DESCRIPTION OF THE PREFERRED EMBODIMENT

The accompanying drawings are included to provide a further understanding of the invention, and are incorporated in and constitute a part of this specification. The drawings illustrate embodiments of the invention and, together with the description, serve to explain the principles of the invention.

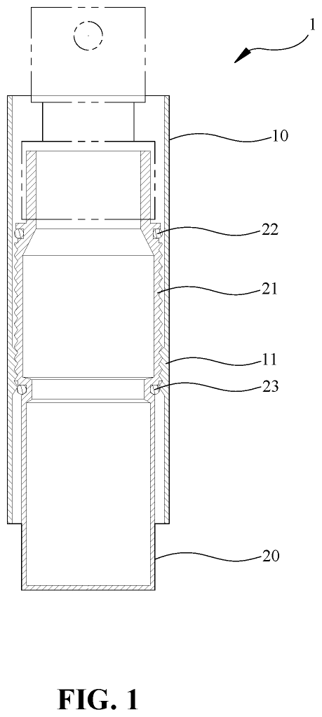

Referring to FIG. 1, FIG. 1 is a schematic view showing of the retractable carrying container of the present invention. The retractable carrying container 1 of the present invention comprises: an outer shell 10 and an inner shell 20. The inner surface of the outer shell 10 is disposed with a first thread 11, and the outer surface of the inner shell 20 is disposed with a second thread 22, wherein the first thread 11 of the outer shell 10 and the second thread 22 of the inner shell 20 are in contact with each other and closely fit.

Further, the outer shell 10 is a hollow cylinder, the inner shell 20 is disposed in the space of the hollow cylinder of the outer shell 10, and the outer shell 10 and the inner shell 20 move with respect to each other by the mutual action between the first thread 11 and second thread 21.

Furthermore, the outer surface of the inner shell 20 is disposed with an upper stopper 22 and a lower stopper 23. The upper stopper 22 is arranged on the upper edge of the second thread 21, and the lower stopper 23 is arranged on lower edge of the second thread 21. When the upper stopper 22 or the lower stopper 23 touches the first thread 11 on the inner surface of the outer shell 10, an additional force must be applied to the second thread 21 on the outer surface of the inner shell 20 to continue moving.

Wherein, the inner shell 20 also comprises a carrying space, the carrying space has an opening. In other words, the carrying space is an unsealed carrying space. The upper stopper 22 and the lower stopper 23 are annular stopper parts, and the first thread 11 and the second thread 21 drive the outer shell 10 and the inner shell 20 to move by moving in mutual rotation with respect to each other.

It should be noted that the total stroke length of the second thread 21 is greater than the total stroke length of the first thread 11, and the outer shell 10 and the inner shell 20 are mutually connected by the first thread 11 and the second thread 21. The distance between the upper stopper 22 and the lower stopper 23 is the range within which the lowest and highest positions that the inner shell 20 can be move to.

The retractable carrying container 1 shown in FIG. 1 is in the state when the lower stopper 23 is in contact with the first thread 11. Since the lower stopper 23 is already at the lowermost edge of the second thread 21, and the path of movement between the first thread 11 and the second thread 21 has been blocked, therefore, this state marks the highest position that the inner shell 20 of the retractable carrying container 1 can be at.

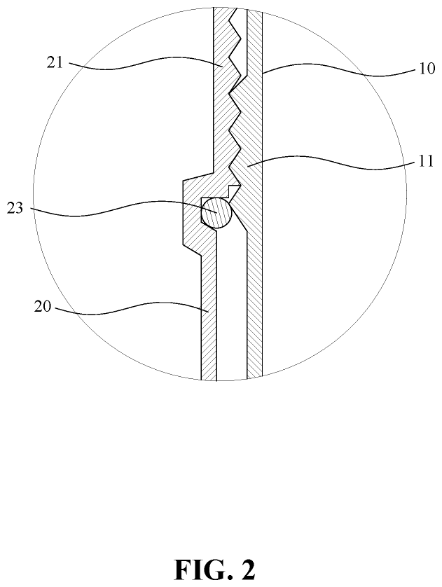

Specifically, referring to FIG. 2. FIG. 2 is a partial enlarged view of the first thread 11, the second thread 21, and the lower stopper 23 in the above state. The lower stopper 23, as seen in FIG. 2, touches the lowermost edge of the first thread 11 and blocks the continued movement of the second thread 21, that is, the stroke of the second thread 21 of the inner shell 20 has reached the highest point, and additional force is required to continue moving. If a force is applied at this point, the inner shell 20 will be separated from the outer shell 10; that is, the inner shell 20 will be taken out, and the contents can be replaced or added.

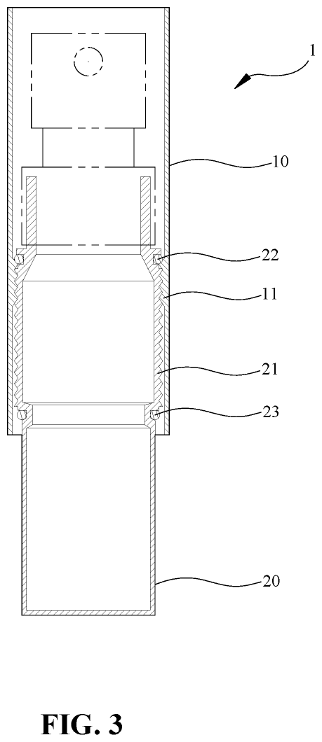

Next, referring to FIG. 3, FIG. 3 is another schematic view showing of the retractable carrying container of the present invention. In this state, the upper stop 22 is in contact with the uppermost edge of the first thread 11, blocking the movement of the second thread 21, so this state marks the lowest position where the inner shell 20 of the retractable carrying container 1 can be.

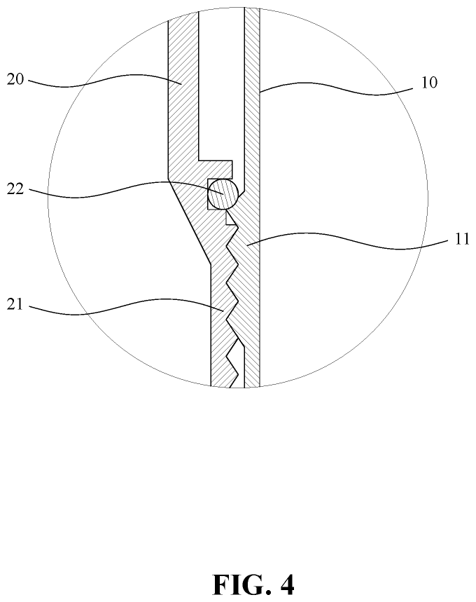

Similarly, referring to FIG. 4, FIG. 4 is a partial enlarged view of the first thread 11, the second thread 21, and the lower stopper 23 in another state. The upper stopper 22, as seen in FIG. 4, touches the uppermost edge of the first thread 11 and blocks the stroke of the second thread 21, that is, the inner shell 20 can no longer be lowered by the stroke of the second thread 21.

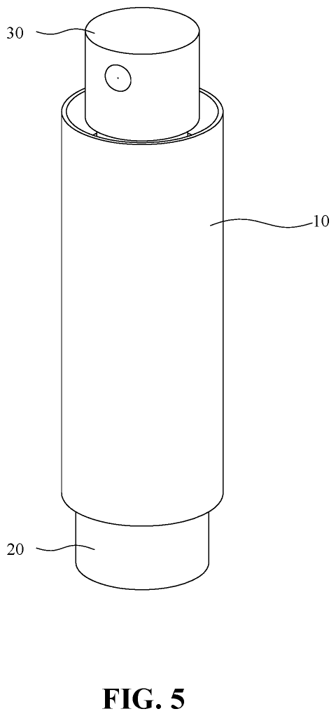

For an application example of the retractable carrying container 1 of the present invention, refer to FIGS. 1-4 and FIG. 5. FIG. 5 shows one of the application examples of the present invention. The inner shell 20 of the retractable carrying container 1 of the present invention has a carrying space, and the carrying space of the inner shell 20 has an opening, and an application head 30 is installed on the opening.

In the present application example, the application head 30 installed on the opening of the carrying space of the inner shell 20 is a spray head, and the carrying space of the inner shell 20 contains liquid, such as, perfume.

To use, the user should rotate the outer shell 10 and the inner shell 20, and the first thread 11 and the second thread 21 are mutually actuated, so that the application head 30 exposes the upper edge of the outer shell 10. In addition, when finishing using, the outer shell 10 and the inner shell 20 are rotated in opposite directions, so that the application head 30 is hidden in the outer shell 10.

The upper stopper 22 and the lower stopper 23 are used as the scope of retraction of the present invention. The lengths of the first thread 11 and the second thread 21 are designed to make the application head 30 extends completely above the upper edge of the outer shell 10 when at the highest position of the inner shell 20, while the application head 30 is just hidden in the outer shell 10 when at the lowest position of the inner shell 20.

It should be noted that the carrying space of the inner shell 20 of the retractable carrying container 1 of the present invention does not specifically limit the contents carried therein. For example, the carrying space of the inner shell 20 can also be equipped with batteries. In such case, the application head 30 can be a light bulb.

Moreover, the circuit can also be designed as follows: when the application head 30 is exposed, the light bulb is turned on, and the light bulb is turned off when the application head 30 is hidden.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A retractable carrying container, comprising:
an outer shell, the outer shell being a hollow cylinder, and disposed with a first thread on inner surface;
an inner shell, having a carrying space, disposed inside the outer shell, and disposed with a second thread on outer surface, the second thread matching first thread;
an upper stopper, disposed on upper edge of the second thread of the inner shell; and
a lower stopper, disposed on lower edge of the second thread of the inner shell;
wherein the outer shell and the inner shell having different relative positions due to the interaction between the first thread and the second thread, and the distance between the upper stopper and the lower stopper defining a range of the lowest and highest positions of the inner shell.

2. The retractable carrying container according to claim 1, wherein the carrying space of the inner shell has an opening, and an application head is disposed at the opening.

3. The retractable carrying container according to claim 1, wherein the upper block and the lower block are ring-shaped blocking elements.

4. The retractable carrying container according to claim 1, wherein the first thread and the second thread drive the movement of the outer shell and the inner shell through mutual rotation to change the relative positions of the outer shell and the inner shell.

5. The retractable carrying container according to claim 1, wherein the second thread has a total stroke length greater than the total stroke length of the first thread.

6. The retractable carrying container according to claim 1, wherein when the lower stopper is in contact with the first thread, the lower stopper is already at the lowermost edge of the second thread, which is the highest position where the inner shell can be.

7. The retractable carrying container according to claim 1, wherein when the upper stopper is in contact with the first thread, the upper stopper is already at the uppermost edge of the second thread, which is the lowest position where the inner shell can be.

8. The retractable carrying container according to claim 2, wherein the outer shell and the inner shell are rotated, and through the interaction of the first thread and the second thread, the application head is raised above the upper edge of the outer shell and exposed.

9. The retractable carrying container according to claim 2, wherein the application head is completely exposed above the upper edge of the outer shell when the lower stopper of the inner shell touches the first thread.

10. The retractable carrying container according to claim 2, wherein the application head is completely hidden in the outer shell when the upper stopper of the inner shell touches the first thread.
